(19) United States
(12) Patent Application Publication
(10) Pub. No.: US 2013/0207886 A1
(43) Pub. Date: Aug. 15, 2013

(54) VIRTUAL-PHYSICAL ENVIRONMENTAL SIMULATION APPARATUS

(71) Applicant: Orthro Hall, San Diego, CA (US)

(72) Inventor: Orthro Hall, San Diego, CA (US)

(21) Appl. No.: 13/370,814

(22) Filed: Feb. 10, 2012

(51) Int. Cl. G09G 5/00

(52) U.S. Cl. 345/156

(57) ABSTRACT

A reactive virtual-physical perception suit apparatus, adapted for interactivity between a virtual environment and a physical environment is disclosed. A reactive virtual-physical perception circuit apparatus is adapted to process information transformation matrices between the virtual environment and the physical environment. The reactive virtual-physical perception suit apparatus is adapted for training environment emulations.

### FIELD

The present disclosure relates to virtual-physical reactive environments generally used as a training environment simulation to prepare for real-world environments.

### BACKGROUND

Training simulations for real-world physical activities has always been hindered by limitations inherent in a training environment. For example, in a martial arts class, one trains against a human opponent. In such training, one generally does not desire to physically harm the human opponent, even though many of the martial arts moves are designed specifically to bring quick and specific physical harm to an opponent. One will generally never intentionally be struck by the human opponent in a martial arts class, whereas in a real-world situation, one might have to deal with the issue of being struck, and still needing to perform martial arts moves. Similarly, if an opponent is struck in a certain way, their responsiveness may be compromised in how they strike back. Traditional training environment simulations generally do not provide the opportunity to train where one might actually be struck and still need to fight, or strike an opponent and better understand the change in opponent responsiveness. Much is lost in such a traditional training environment simulation, partially because one will never actually be struck and therefore need to appreciate the best responsive choice when struck in such a manner.

The present disclosure provides an elegant solution to the aforementioned problems, which have plagued true, real-world training environmental simulations for centuries, to more succinctly model real-world environments.

### SUMMARY

In one embodiment of the present teachings, a reactive virtual-physical perception suit system, adapted to cover a body portion of a user, is disclosed. The reactive virtual-physical perception suit system generally comprises a virtual-physical environment, a virtual perception detector interface element, a physical perception detector interface element, a virtual impulse signal translation element, a physical impulse signal translation element, a body covering member, and an electrical power source.

### BRIEF DESCRIPTION OF THE DRAWINGS

Embodiments of the present disclosure will be more readily understood by reference to the following figures, in which like reference numbers and designations indicate like elements.

FIG. 1a illustrates a reactive virtual-physical perception suit apparatus, of one embodiment of the present teachings.

FIG. 1b illustrates a schematic diagram of a reactive virtual-physical perception circuit apparatus, of one embodiment of the present teachings.

FIG. 1c illustrates a virtual-physical hand-wear apparatus, of one embodiment of the present teachings.

FIG. 1d illustrates a virtual-physical head-wear apparatus, of one embodiment of the present teachings.

FIG. 1e illustrates a virtual-physical foot-wear apparatus, of one embodiment of the present teachings.

FIG. 2a illustrates a virtual to physical transformation, of one embodiment of the present teachings.

FIG. 2b illustrates a virtual-physical transformation matrix, of one embodiment of the present teachings.

FIG. 3 illustrates a physical to virtual transformation matrix method, of one embodiment of the present teachings.

### DETAILED DESCRIPTION

### Overview

The present teachings generally describe an apparatus adapted for a user to interact with a virtual object and/or person in a virtual-physical environment, in such a manner that the user physically feels an impact from and to the virtual object and/or person. In one illustrative exemplary embodiment, a reactive virtual-physical perception suit system 100 is adapted for martial arts combat training. In this embodiment, a user wears an article of clothing as described below, in a virtual-physical environment, wherein the user can physically feel a physical impact, such as for example a punch, a kick, or a sword blow, either upon a virtual opponent, or from a virtual opponent. The present teachings are useful for providing a more realistic training environment for the user.

As used herein, the term “digital processor” or “microprocessor” is meant generally to include all types of digital processing apparatuses including, without limitation, digital signal processors (DSPs), reduced instruction set computers (RISC), general-purpose (CISC) processors, microprocessors, and application-specific integrated circuits (ASICs). Such digital processors may be contained on a single unitary IC die, or distributed across multiple components. Exemplary DSPs include, for example, the Motorola MSC-8101/8102 “DSP farms”, the Texas Instruments TMS320C6x, or Lucent (Agere) DSP16000 series.

The word “reality” has become a subjective term, due to modern advances in virtual reality technology. Mixed reality (encompassing both augmented reality and augmented virtuality) refers to the merging of real and virtual worlds to produce new environments and visualizations where physical and digital objects co-exist and interact in real time. A Virtuality Continuum extends from the completely real through to the completely virtual environment with augmented reality and augmented virtuality ranging between. The present teachings allow a user to operate in a mixed reality environment, interacting with virtual objects and/or virtual persons.

The traditionally held view of a Virtual Reality environment is one in which the participant-observer is totally immersed in, and able to interact with, a completely synthetic world. Such a world may mimic the properties of some real-world environments, either existing or fictional; however, it can also exceed the bounds of physical reality by creating a world in which the physical laws ordinarily governing space, time, mechanics, and material properties, no longer hold. What may be overlooked in this view is that the Virtual Realty label is also frequently used in association with a variety of other environments, to which total immersion and complete synthesis do not necessarily pertain, but which fall somewhere along a Virtuality Continuum. The present teachings are related to technologies that involve the merging of real and virtual worlds.

In a physics context, the term “interreality system” refers to a virtual reality system coupled to its real-world counterpart. In one conceptual illustrative example, an interreality system comprises a real physical pendulum coupled to a pendulum that only exists in virtual reality. This system apparently has two stable states of motion: a “Dual Reality” state in which the motion of the two pendula are uncorrelated and a “Mixed Reality” state in which the pendula exhibit stable phase-locked motion which is highly correlated. For the purposes of the present teachings, the use of the terms “Mixed Reality” and “interreality” in the context of physics is clearly defined but may be slightly different than in other fields.

The human tactual sense is generally regarded as made up of two subsystems: the tactile and kinesthetic senses. Tactile (or cutaneous) sense refers to the awareness of stimulation to the body surfaces. Kinesthetic sense refers to the awareness of limb positions, movements and muscle tensions. The term haptics refers to manipulation as well as perception through the tactual sense. Some embodiments of the present teachings employ haptics, however the scope of the present disclosure is not limited to haptics. U.S. Pat. No. 7,800,609 is hereby incorporated by reference in its entirety, as if disclosed herein in full.

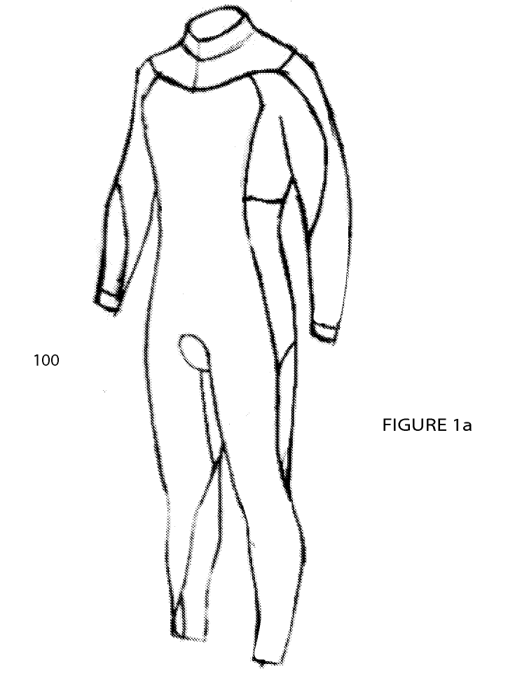

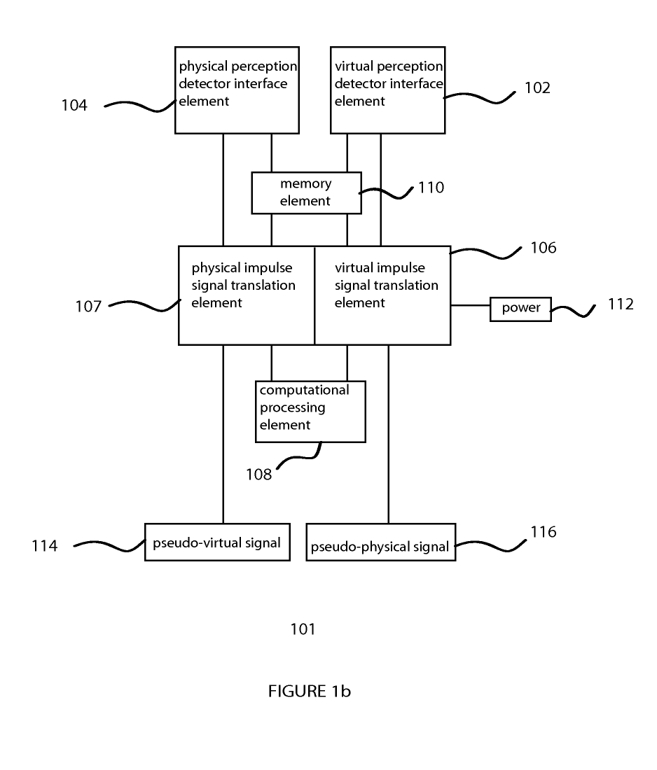

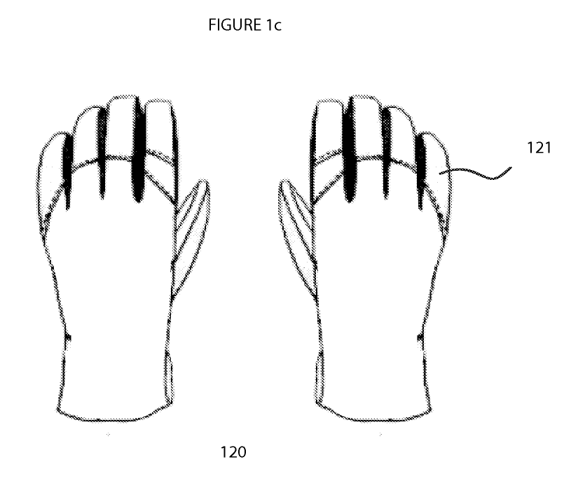

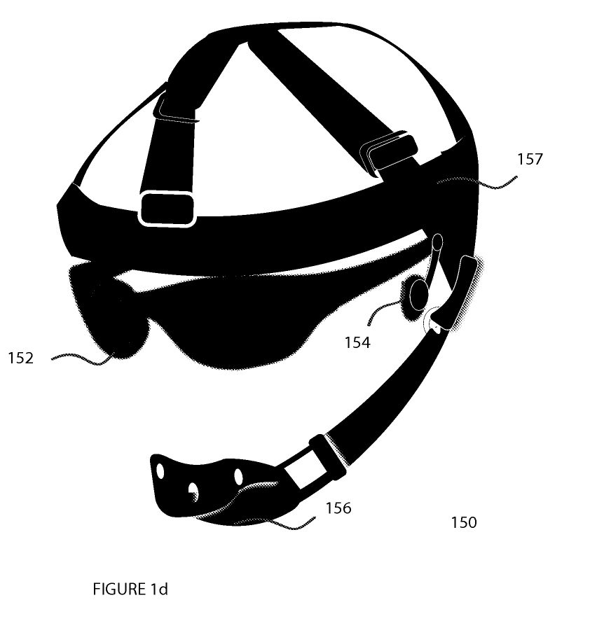

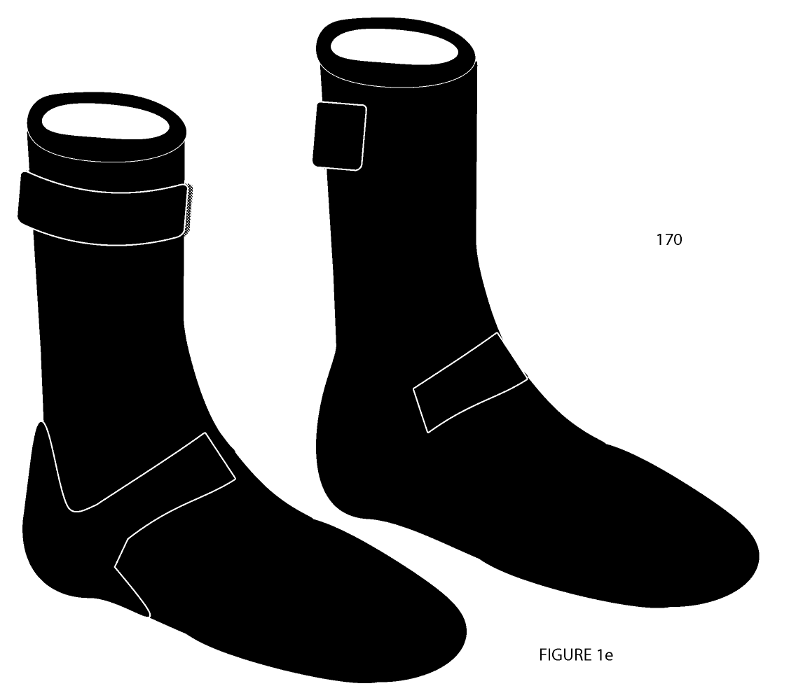

Referring now generally to FIGS. 1a through FIG. 1e, a reactive virtual-physical perception suit system 100 is disclosed. The reactive virtual-physical perception suit system 100 generally comprises a virtual-physical environment, a virtual perception detector interface element 102, a physical perception detector interface element 104, a virtual impulse signal translation element 106, a physical impulse signal translation element 107, a body covering member 100, and a power source 112.

The reactive virtual-physical perception suit system 100 comprises a virtual-physical environment, adapted for interactivity between a virtual environment and a physical environment. The virtual-physical environment is adapted for a user to simultaneously interact with elements within both the virtual environment and the physical environment. The virtual-physical environment is built with and comprises a combination of software algorithms, firmware, and hardware designed to emulate an environment wherein a physical user, operating in a physical environment, is able to tangibly interact with virtual manifestations of persons and objects, as will be described further below.

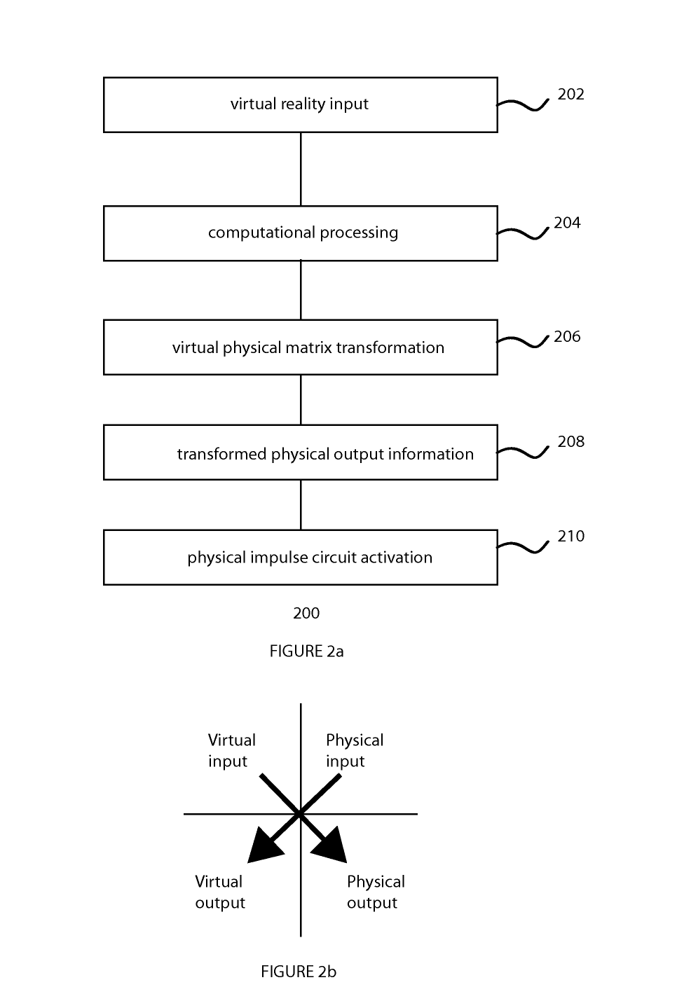

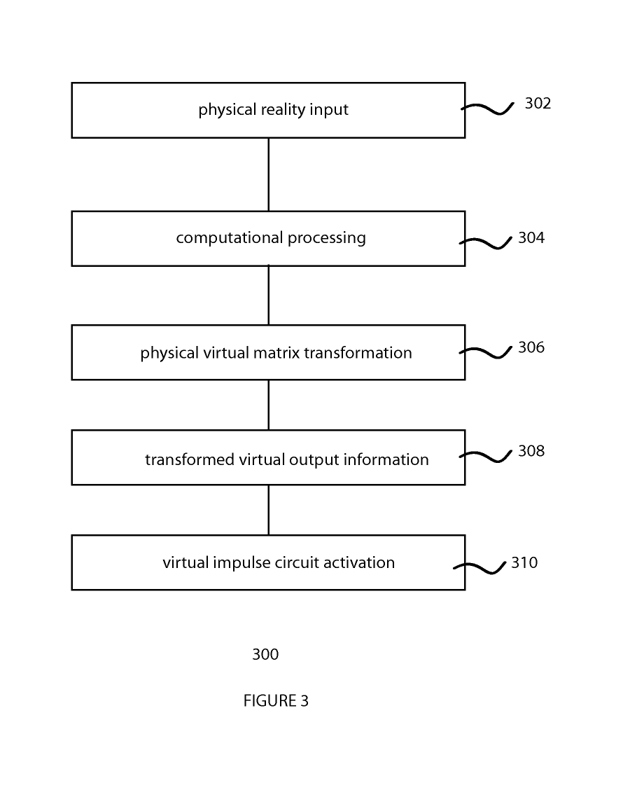

Mapping back and forth between a virtual reality environment and a physical reality environment can be accomplished in multiple ways, using the present teaching. The present disclosure is meant to be illustrative of specific implementations of the present teachings, but is not intended to be limited in scope to the embodiments disclosed herein, due to the myriad of specific software and hardware circuit implementations which may be reduced to practice using the techniques described herein. In one embodiment, a mathematical basis for software algorithms, firmware and hardware, adapted to bi-directionally transform information between a virtual space and a physical space are defined by a virtual-physical linear transformation, as will now be described in greater detail. In this embodiment, a virtual-physical environment matrix is defined and transformed between a virtually defined space and a physically defined space, such as for example as represented by FIGS. 2a, 2b, and 3, wherein coordinates of space and time are represented.

In one exemplary embodiment, three spatial coordinates (i.e. x, y, z) and one temporal coordinate define a virtual-physical environment matrix system of equations, such as defined by Equation 1.

Vᵢₙ(x,y,z,t)×V_{key}=Pₒᵤₜ(x,y,z,t) Equation 1

As described by Equation 1, an input to the virtual-physical environment matrix system is further defined as being sourced from a virtual source in a virtually defined space, which is captured as a vector array of virtual information Vᵢₙ(x,y,z,t). To obtain a physical output vector array Pₒᵤₜ(x,y,z,t), which may be implemented as software and/or hardware for a user interactivity, the vector array of virtual information Vᵢₙ(x,y,z,t) is transformed into a physical output vector array Pₒᵤₜ(x,y,z,t) by multiplying by a virtual vector key V_{key}. The virtual vector key, V_{key} comprises spatial and temporal information which is either predetermined, or dynamically calculated, and adapted to correspond to virtual space physics characteristics, such as for example strength and height of an opponent, relative weight in a gravitational field, sharpness of a sword blade, etc. Multiplying the vector array of virtual information Vᵢₙ(x,y,z,t) by the virtual vector key V_{key} yields a physical output vector array Pₒᵤₜ(x,y,z,t), which is adapted to provide information for a reactive virtual-physical perception suit system 100. The reactive virtual-physical perception suit system 100 is adapted to use the physical output vector array Pₒᵤₜ(x,y,z,t), to actuate electromechanical devices embedded within the reactive virtual-physical perception suit system 100, which are adapted to provide mechanical and thermal interactivity with a user. A circuit for performing the described transformation will now be disclosed.

As shown in FIG. 1b, in one illustrative exemplary embodiment, a schematic diagram of a reactive virtual-physical perception circuit apparatus 101 is disclosed. The reactive virtual-physical perception circuit apparatus 101 is embedded in a virtual-physical article of clothing worn by the user. Exemplary embodiments of the virtual-physical articles of clothing include the reactive virtual-physical perception suit apparatus 100 as illustrated in FIG. 1a, a virtual-physical hand-wear apparatus 120 as illustrated in FIG. 1c, a virtual-physical head-wear apparatus 150 as illustrated in FIG. 1d, a virtual-physical foot-wear apparatus 170 as illustrated in FIG. 1e. Although the aforementioned specific articles of clothing worn by a user have been disclosed, such are not meant to be limiting, and literally any article of clothing may be embedded with the reactive virtual-physical perception circuit apparatus 101. Therefore, literally any article of clothing performing virtual-physical reactive transformations as those described herein are within the scope of the current disclosure, comprising the reactive virtual-physical perception circuit apparatus 101.

As shown in the schematic diagram of the reactive virtual-physical perception circuit apparatus 101 of FIG. 1b, a virtual perception detector interface element 102, is adapted to detect a virtual impulse signal of a virtual reality source in the virtual environment, such as for example information corresponding to movement of a virtual objects and/or person. The virtual perception detector interface element 102 detects information output from virtual objects and/or persons, stores the detected information into a memory element 110. The memory element 110 may be a non-volatile memory, such as flash memory, RAM, DRAM, CPU cache, SRAM and/or volatile memory. In one embodiment, a memory element 110 comprises a voltage, such as for example as an electric field. In one embodiment, a capacitor stores the information in a memory element 110. Information in the memory element 110 may be stored in digital or analog format.

As shown in FIG. 1b, a virtual impulse signal translation element 106 is adapted to access a memory element 110 to retrieve the detected virtual impulse signal information of a virtual object and/or person. The virtual impulse signal translation element 106 is further adapted to input the stored virtual impulse signal information to a computational processing element 108 in order to execute the linear transformation discussed above. In one embodiment, a virtual impulse signal translation element 106 formats a detected virtual impulse signal into a vector array of virtual information Vᵢₙ(x,y,z,t) , which is then multiplied by a virtual vector key V_{key} to generate a physical output vector array Pₒᵤₜ(x,y,z,t), which may be adapted as software and/or hardware for generating mechanical impulse signals in portions of a reactive virtual-physical perception suit system 100 corresponding to the physical output. In one embodiment, a physical output vector array Pₒᵤₜ(x,y,z,t), is stored as a pseudo-physical signal set 116.

In one illustrative exemplary embodiment, a virtual person who is an opponent in a martial arts simulation physical-virtual environment performs a kick directed at a user wearing the reactive virtual-physical perception suit system 100. A virtual perception detector interface element 102 captures information generated by the kicking motion of the virtual opponent, and then stores the information in a memory element 110. A virtual impulse signal translation element 106 accesses the memory element 110 to transfer and transform the stored virtual information into a vector array of virtual information Vᵢₙ(x,y,z,t), corresponding to the virtual opponent's kicking motion. In one embodiment, the virtual impulse signal translation element 106 comprises a microprocessing element. A virtual vector key V_{key} is also stored in, and accessed from, the memory element 110, by the virtual impulse signal translation element 106. In one embodiment, the virtual vector key V_{key} stores information specific to the virtual opponent, such as for example height, weight, strength, dexterity, and/or speed. A computational processing element 108 executes instructions to multiply the vector array of virtual information Vᵢₙ(x,y,z,t) by the virtual vector key V_{key} to generate a physical output vector array Pₒᵤₜ(x,y,z,t). In one embodiment, the computational processing element 108 comprises a microprocessing element.

Generally, a physical output vector array Pₒᵤₜ(x,y,z,t), is a mapping from a virtual representation to a physical representation. For example, in the aforementioned embodiment wherein the virtual opponent performs a kick, from which the virtual information is captured and processed by the reactive virtual-physical perception circuit apparatus 101, thereby generating the physical output vector array Pₒᵤₜ(x,y,z,t), the reactive virtual-physical perception suit system 100 is adapted to mechanically execute information stored in the physical output vector array Pₒᵤₜ(x,y,z,t), such as for example generating a physical impact force directed at the user, corresponding to the virtual opponent's kicking motion. In one embodiment, a reactive virtual-physical perception suit system 100 is adapted to provide a physical force, mechanically actuated based on a physical output vector array Pₒᵤₜ(x,y,z,t), stored as a pseudo-physical signal set, such as for example providing a physical force impacting a user's leg if a virtual opponent kicks at a virtual location in a virtual-physical environment corresponding to the user's leg.

In one embodiment, a haptic element is employed to actuate information stored in a physical output vector array Pₒᵤₜ(x,y,z,t). The haptic elements are distributed about a reactive virtual-physical perception suit system 100. Haptics is enabled by actuators that apply forces to the skin for touch feedback between a virtual environment and a physical environment in a virtual-physical environment. The actuator provides mechanical motion in response to an electrical stimulus. Most early designs of haptic feedback use electromagnetic technologies such as vibratory motors with an offset mass, such as the pager motor which is in most cell phones or voice coils where a central mass or output is moved by a magnetic field. These electromagnetic motors typically operate at resonance and provide strong feedback, but have limited range of sensations. In some embodiments, haptic actuators include Electroactive Polymers, Piezoelectric, and Electrostatic Surface Actuation.

In one embodiment, employing haptic feedback to holographic projections is utilized to create a virtual-physical environment. The feedback allows the user to interact with a hologram and receive tactile response as if the holographic object were real. In one embodiment, ultrasound waves are employed to create acoustic radiation pressure, which provides tactile feedback as a user interact with the holographic object.

Furthermore, as shown in the schematic diagram of the reactive virtual-physical perception circuit apparatus 101 of FIG. 1b, a physical perception detector interface element 104, is adapted to detect a physical impulse signal of a physical reality source in the physical environment, such as for example information corresponding to movement of a user wearing the reactive virtual-physical perception suit system 100. The physical perception detector interface element 104 detects information output from physical objects and/or persons, and then stores the detected information into a memory element 110.

As shown in FIG. 1b, a physical impulse signal translation element 107 is adapted to access a memory element 110 to retrieve the detected physical impulse signal information of a physical object and/or person. The physical impulse signal translation element 107 is further adapted to input the stored virtual impulse signal information to a computational processing element 108 in order to execute a linear transformation. In one embodiment, a physical impulse signal translation element 107 formats a detected virtual impulse signal into a vector array of physical information Pᵢₙ(x,y,z,t), which is then multiplied by a physical vector key P_{key} to generate a virtual output vector array Vₒᵤₜ(x,y,z,t), which may be adapted as software and/or hardware for generating virtual impulse signals in a virtual-physical environment corresponding to the virtual output. In one embodiment, a virtual output vector array Vₒᵤₜ(x,y,z,t), is stored as a pseudo-virtual signal set.

Pᵢₙ(x,y,z,t)×P_{key}=Vₒᵤₜ(x,y,z,t) p Equation 2

As described by Equation 2, an input to the virtual-physical environment matrix system is further defined as being sourced from a physical source in a physically defined space, which is captured as a vector array of physical information Pᵢₙ(x,y,z,t). To obtain a virtual output vector array Vₒᵤₜ(x,y,z,t), which may be implemented as software and/or hardware for a user interactivity, the vector array of physical information Pᵢₙ(x,y,z,t) is transformed into a virtual output vector array Vₒᵤₜ(x,y,z,t) by multiplying by a physical vector key P_{key}. The physical vector key, P_{key} comprises spatial and temporal information which is either predetermined, or dynamically calculated, and adapted to correspond to physical space physics characteristics, such as for example strength and height of an opponent, relative weight in a gravitational field, sharpness of a sword blade, etc. Multiplying the vector array of physical information Pᵢₙ(x,y,z,t) by the physical vector key P_{key} yields a virtual output vector array Vₒᵤₜ(x,y,z,t), which is adapted to provide information for a reactive virtual-physical perception suit system 100. The reactive virtual-physical perception suit system 100 is adapted to use the virtual output vector array Vₒᵤₜ(x,y,z,t), to actuate electromechanical devices embedded within the reactive virtual-physical perception suit system 100, which are adapted to provide mechanical and thermal interactivity with a user.

In one embodiment, a physical matrix array, represented in Equation 2 as Pᵢₙ(x,y,z,t), characterizing a physical space occupied by the user, contains a plurality of data points representing coordinate vectors and a movement vectors of the user coordinates and movements respectively, in a Cartesian coordinate space. The physical impulse signal translation element 107 operates to transform Pᵢₙ(x,y,z,t) into a pseudo-virtual signal matrix array, represented in Equation 2 as Vₒᵤₜ(x,y,z,t).

The pseudo-virtual signal matrix array Vₒᵤₜ(x,y,z,t) is a mathematical matrix representation of the input physical information, transposed into a virtual space representation. Relative coordinate vector spacing and movement vector spacing is preserved in the matrix transformation, in order to render a high resolution virtual rendering of input physical information.

In one illustrative exemplary embodiment, wherein the reactive virtual-physical perception suit system 100 is adapted for martial arts training, the user might perform a kick against a virtual combatant. The physical coordinate vectors and physical movement vectors would be captured by the physical perception detector interface element 104, and stored in a physical matrix array P_{kick}(x,y,z,t), in the memory element 110. The physical impulse signal translation element 107 retrieves the physical matrix array P_{kick}(x,y,z,t), stored in the memory element 110, and translates the physical matrix array P_{kick}(x,y,z,t) into a virtual matrix array V_{pseudo-kick}(x,y,z,t), which is a virtual representation of the physical kick. The matrix translation is achieved by multiplying the physical matrix P_{kick}(x,y,z,t) by a physical vector key P_{key}. The coordinate vectors and movement vectors associated with the physical kick are mapped into virtual space, where force and velocity vectors are calculated in order to yield the proper virtual rendering of the physical kick on the virtual combatant.

In one embodiment, a reactive virtual-physical perception suit system 100 comprises a wireless communication circuit element, adapted to send and receive communication signals. In this embodiment, an antenna element is embedded in the reactive virtual-physical perception suit system 100, such as for example a micro-strip antenna. The wireless communication circuit element is adapted to communicate with an external computing element, which is external to the reactive virtual-perception suit system 100. The external computing element may optionally comprise a microprocessor element, a computer server, or literally any device capable of processing data.

Some embodiments of the present teachings may be adapted for martial arts training. In one illustrative exemplary embodiment, reactive virtual-physical perception suit system 100 is adapted for martial arts combat scenarios, wherein a user interacts with a virtual combatant. In these embodiments, the user, wearing the reactive virtual-physical perception suit system 100, inputs physical information to a physical perception detector interface element 204 by making physical movements. In one embodiment, an electromechanical transducer is employed to capture the input physical information. Alternate embodiments include nanoelectromechanical systems (NEMS), to provide very high resolution of information transduction regarding the input physical information of the user. The input physical information is stored in a memory element 110, wherefrom it may later be retrieved for further processing. A physical impulse signal translation element 107 retrieves the input physical information stored in the memory element 110, and performs a mathematical operation on the input physical information, as described above.

In one embodiment, a virtual-physical matrix transformation is a non-linear transformation. In one embodiment, a transformation that is non-linear on a n-dimensional Euclidean space Rn, can be represented as linear transformations on the n+1-dimensional space Rn+1. These include both affine transformations (such as translation) and projective transformations. In one embodiment, a 4×4 transformation matrix is employed to define three dimensional virtual and/or physical objects and/or users. These n+1-dimensional transformation matrices are called, depending on their application, affine transformation matrices, projective transformation matrices, or more generally non-linear transformation matrices. With respect to a n-dimensional matrix, a n+1-dimensional matrix can be described as an augmented matrix.

Although the aforementioned embodiments have been primarily described and adapted for a reactive virtual-physical perception suit system 100, the present teachings are also intended to be adapted for use in literally any article which a user might wear, such as for example a hand-wear apparatus 120 as illustrated in FIG. 1c, a head-wear apparatus 150 as illustrated in FIG. 1d, and/or a foot-wear apparatus 170 as illustrated in FIG. 1e. A reactive virtual-physical perception circuit apparatus 101 is readily adapted for use in the aforementioned embodiments, as described above with respect to the reactive virtual-physical perception suit system 100. The disclosed articles of clothing are meant to be illustrative of exemplary embodiments, but are not meant to be limiting in scope. Therefore, literally any kind of body covering may be adapted for use in accordance with the present teachings employing the reactive virtual-physical perception circuit apparatus 101.

Referring specifically to FIG. 1d, a head-wear apparatus 150 is disclosed. The head-wear apparatus 1d may optionally include a visual apparatus 152, an audio apparatus 154, a head-portion apparatus 157 and/or a chin-strap apparatus 156. The visual apparatus 152 enables a user to view a virtual-physical environment as described above. The visual apparatus 152 may optionally comprise glasses, contact lenses, goggles, or literally any form of apparatus for viewing in a virtual-physical environment. In one embodiment, a head-wear apparatus 150 comprises a mask, adapted to substantially cover a user's face, further comprising a reactive virtual-physical perception circuit apparatus 101, wherein transduction elements convert virtual information into physical, mechanical manifestations which a user can physically feel. As described above, the reactive virtual-physical perception circuit apparatus 101 is embedded into the fabric of the mask. The transduction elements are also woven into the fabric of the mask. In this embodiment, when the user is interacting with a virtual opponent, and the virtual opponent contacts the user's face, such as a punch, the reactive virtual-physical perception circuit apparatus 101 is adapted to activate the transduction elements, NEMS, or other system adapted for manifesting mechanical forces based on virtual information.

Referring now to FIG. 2a, in one embodiment, a reactive virtual-physical perception suit system 100 employs a virtual to physical impulse transformation method 200. The virtual to physical impulse transformation method 200 may be implemented as a combination of software and hardware. At a STEP 202, a virtual reality input is received from a virtual source, such as for example a virtual opponent or object. In one embodiment, the virtual reality input is received via a software algorithm. At a STEP 204, a computational processing method is implemented employing a microprocessor to operate on the virtual reality input received in the STEP 202. At the computational processing STEP 204, a mathematical operation is performed on the virtual reality input from STEP 202 to create a virtual-physical matrix as described in greater detail above with respect to the reactive virtual-physical perception circuit apparatus 101. The microprocessor performs mathematical operations on the virtual-physical matrix at a STEP 206 a virtual-physical matrix transformation is performed, which outputs a transformed physical output information matrix at a STEP 208. The transformed physical output information matrix of STEP 208 is formatted such that it is compatible with transduction elements adapted for initiating a physical impulse circuit activation at a STEP 210.

FIG. 2b illustrates a simple matrix transformation relationship between a virtual reality input space (quadrant 2) and a physical reality output space (quadrant 4). FIG. 2b further illustrates a matrix transformation relationship between a physical reality input space (quadrant 1) and a virtual reality output space (quadrant 3).

Referring now to FIG. 3, one embodiment of a physical to virtual transformation matrix method 300 is disclosed. The physical to virtual transformation matrix method 300 is executed as a combination of software and hardware, such as for example in a reactive virtual-physical perception circuit apparatus 101 of FIG. 1b. In one embodiment, at a STEP 302, a physical reality input is detected at a physical perception detector interface element 104. Physical reality input is sourced from a physical user, such as for example a user wearing a reactive virtual-physical perception suit system 100. The physical reality input STEP 302 may be accepted employing a transducer to transform mechanical energy into electrical signals, representative of the physical user movements, such as for example an arm or leg motion. At a computational processing STEP 304, a mathematical operation is performed on the physical reality input from STEP 302 to create a physical virtual matrix, in a reciprocal manner as that described above with respect to the virtual-physical matrix transformation. A microprocessor performs the mathematical operations on the physical-virtual matrix to effect a physical-virtual matrix transformation at a STEP 306, wherein an output is produced and stored at a STEP 308 for a transformed virtual output information. The transformed virtual output information is a virtual representation of the user's physical movements. The transformed virtual output information from STEP 308 is used at a STEP 310 of a virtual impulse circuit activation, wherein the transformed virtual output information is employed to interact with a virtual object and/or person. In one exemplary embodiment, a user wearing a reactive virtual-physical perception suit system 100 kicks his leg at a virtual opponent. The kicking information is transformed as described by a physical to virtual transformation matrix method 300, wherein transformed virtual output information is employed to provide data to “kick” the virtual opponent. Other relevant physical information is also included in the computations, such as for example the user's weight, height, strength, and speed.

Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim. The present teachings may be adapted for use by a human user, but is not limited in scope to humans. That is, the present teachings may be readily adapted for use in training animals.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. A reactive virtual-physical perception suit system, adapted to cover a body portion of a user, comprising:
a.) a virtual-physical environment, adapted for interactivity between a virtual environment and a physical environment;
b.) a virtual perception detector interface element, adapted to detect a virtual impulse signal of a virtual reality source in the virtual environment, wherein the virtual impulse signal information is stored in a memory element;
c.) a physical perception detector interface element, adapted to detect a physical impulse signal of a physical reality source in the physical environment, wherein the physical impulse signal information is stored in the memory element;
d.) a virtual impulse signal translation element, adapted to access the virtual impulse signal information stored in the memory element to input into a computational processing element, wherein the virtual impulse signal is thereby translated into a pseudo-physical signal, adapted for interacting directly with the virtual environment;
e.) a physical impulse signal translation element, adapted to access the physical impulse signal information stored in the memory element to input into a computational processing element, wherein the physical impulse signal is thereby translated into a pseudo-virtual signal, adapted for interacting directly with the physical environment;
f.) a body covering member, adapted to substantially cover the body portion of the user intended for virtual-physical interactivity, adapted to provide a physical response for the pseudo-physical signal, and;
g.) a power source, adapted for providing power to the reactive virtual-physical perception suit system.

2. The reactive virtual-physical perception suit system of claim 1, further adapted to store a virtual-physical software program.

3. The reactive virtual-physical perception suit system of claim 1, further comprising a wireless communication circuit element, adapted to send and receive communication signals.

4. The reactive virtual-physical perception suit system of claim 1, wherein the virtual-physical impulse is optionally a mechanical impulse or an electrical impulse.

5. The reactive virtual-physical perception suit system of claim 1, wherein the memory element comprises a voltage.

9. A reactive virtual-physical perception suit system, adapted for covering a portion of a user body, comprising:
a.) a virtual-physical environment, adapted for interactivity between a virtual environment and a physical environment;
b.) a virtual perception detector interface element, adapted to detect a virtual impulse signal of a virtual reality source in the virtual environment, wherein the virtual impulse signal information is stored in a memory element;
c.) a physical perception detector interface element, adapted to detect a physical impulse signal of a physical reality source in the physical environment, wherein the physical impulse signal information is stored in the memory element;
d.) a virtual impulse signal translation element, adapted to access the virtual impulse signal information stored in the memory element to input into a computational processing element, wherein the virtual impulse signal is thereby translated into a pseudo-physical signal, adapted for interacting directly with the virtual environment;
e.) a physical impulse signal translation element, adapted to access the physical impulse signal information stored in the memory element to input into a computational processing element, wherein the physical impulse signal is thereby translated into a pseudo-virtual signal, adapted for interacting directly with the physical environment;
f.) a body covering member, adapted to substantially cover the body portion of the user intended for virtual-physical interactivity, adapted to provide a physical response for the pseudo-physical signal, and;
g.) a power source, adapted for providing power to the reactive virtual-physical perception suit system.

10. The reactive virtual-physical perception member of claim 9, further adapted to store a virtual-physical software program.

11. The reactive virtual-physical perception member of claim 9, further comprising a wireless communication circuit element, adapted to send and receive communication signals.)

12. The reactive virtual-physical perception member of claim 9, wherein the virtual-physical impulse is optionally a mechanical impulse or an electrical impulse.

13. The reactive virtual-physical perception member of claim 9, wherein the memory element comprises a voltage.

14. A reactive virtual-physical perception suit means for covering a body portion of a user, comprising:
a.) a virtual-physical environment means for interactivity between a virtual environment and a physical environment;
b.) a virtual perception detector interface means for detecting a virtual impulse signal of a virtual reality source in the virtual environment, wherein the virtual signal information is stored in a memory means;
c.) a physical perception detector interface means for detecting a physical impulse signal of a physical reality source in the physical environment, wherein the physical impulse signal information is stored in the memory means;
d.) a virtual impulse signal translation means for accessing the virtual impulse signal information stored in the memory means to input into a computational processing element, wherein the virtual impulse signal is thereby translated into a pseudo-physical signal, adapted for interacting directly with the virtual environment;
e.) a physical impulse signal translation means for accessing the physical impulse signal information stored in the memory means to input into a computational processing element, wherein the physical impulse signal is thereby translated into a pseudo-virtual signal, adapted for interacting directly with the physical environment;
f.) a body covering means for substantially covering the body portion of the user intended for virtual-physical interactivity, adapted to provide a physical response for the pseudo-physical signal, and;
g.) a power source means for providing power to the reactive virtual-physical perception suit means.

15. The reactive virtual-physical perception suit system of claim 1, wherein the body covering member comprises a mask.
